(19) United States
(12) Patent Application Publication
(10) Pub. No.: US 2014/0321252 A1
(43) Pub. Date: Oct. 30, 2014

(54) OPTICAL INFORMATION DEVICE, TILT DETECTION METHOD, COMPUTER, PLAYER, AND RECORDER

(71) Applicant: Panasonic Corporation, Kadoma-shi, Osaka (JP)

(72) Inventors: Kousei Sano, Osaka (JP); Yoshiaki Komma, Osaka (JP); Kanji Wakabayashi, Kyoto (JP)

(21) Appl. No.: 14/364,527

(22) PCT Filed: Oct. 9, 2013
(86) PCT No.: PCT/JP2013/006032

§ 371 Date: Jun. 11, 2014

(30) Foreign Application Priority Data
Oct. 11, 2012 (JP) 2012-225642

(51) Int. Cl. G11B 7/095; G11B 7/1374

(52) U.S. Cl. CPC G11B 7/0956; G11B 7/1374
USPC 369/47.49

(57) ABSTRACT

A photodetector outputs a first signal and a second signal corresponding to light amounts of the received first light flux and the received second light flux, first and second low band extraction circuits extract low band components of the first signal and the second signal, first and second high band extraction circuits extract high band components of the first signal and the second signal, a differential circuit calculates a difference signal between a high band component difference signal as a difference between the high band component of the first signal and the high band component of the second signal and a low band component difference signal as a difference between the low band component of the first signal and the low band component of the second signal, and a control signal processing section generates a tilt control signal based on the calculated difference signal.

### TECHNICAL FIELD

The present invention relates to an optical information device that reproduces or records information for an optical information medium, a tilt detection method that detects a tilt of the optical information medium, a computer that includes the optical information device, a player that includes the optical information device, and a recorder that includes the optical information device.

### BACKGROUND ART

Conventionally, in general, a CD, a DVD, or a Blu-ray (registered trademark) Disc is widely known as an optical disc. As the recording density of the optical disc is increased, the numerical aperture of an optical system is increased and a sensitivity to a coma aberration caused by a tilt of the optical disc is increased. Consequently, it is important to prevent the occurrence of the coma aberration for stable recording and reproduction of information. As a method for preventing the occurrence of the coma aberration, there is known a method in which the coma aberration is reduced by applying a force in a rotation direction to an actuator of an objective lens in accordance with the tilt of the optical disc to tilt the objective lens. In this method, it is necessary to flow a current in which the tilt amount of the optical disc is precisely reflected as a drive current of the actuator, and it is necessary to combine the method with a method for accurately detecting the tilt amount of the optical disc.

As the method for detecting the tilt amount of the optical disc, there is known a method in which a tilt sensor is provided separately from an optical head, and the tilt amount is detected thereby. However, a position irradiated with a light beams emitted from the tilt sensor does not necessarily match a position irradiated with a light beam emitted from the optical head, and hence an error occurs in the detection of the tilt amount. In addition, since the sensor is provided separately, the structure thereof becomes complicated so that disadvantages such as a reduction in reliability, an increase in device size, and an increase in cost occur.

On the other hand, as another method for detecting the tilt amount of the optical disc, there is known a method that utilizes the structure of the optical disc. In the case of a DVD-RAM, there is known a method that utilizes the structure of a CAPA portion as an address signal region. However, this method has a disadvantage that the optical disc is required to have a special structure. As a method in which the optical disc is not required to have the special structure, for example, Patent Literature 1 or the like is known.

The summary of Patent Literature 1 will be described as a conventional example by using FIG. 22. FIG. 22 is a view showing a configuration of a conventional photodetector.

Reflection light 900 from an optical disc is received by light receiving sections 901a, 901b, 901c, and 901d of the photodetector that is split into four portions. The light receiving sections 901a, 901b, 901c, and 901d output signals corresponding to received light amounts. The signals outputted from the light receiving sections 901a to 901d are converted to voltage signals by I-V amplifiers 902a, 902b, 902c, and 902d. Signals outputted from the I-V amplifier 902a and the I-V amplifier 902b are added up by an adder 903a, while signals outputted from the I-V amplifier 902c and the I-V amplifier 902d are added up by an adder 903b. A subtractor 904 determines a difference signal between an signal outputted from the adder 903a and a signal outputted from the adder 903b.

A signal outputted from the subtractor 904 is inputted to a detector circuit 905 and a low-pass filter 906. The detector circuit 905 outputs a signal proportional to the amplitude of a RF signal included in the difference signal from the subtractor 904. The low-pass filter 906 outputs a low band component of the difference signal from the subtractor 904. The sign of the signal outputted from the detector circuit 905 is inverted by an inverting amplification circuit 907. An output signal of the inverting amplification circuit 907 and an output signal of the low-pass filter 906 are inputted to a multiplier 908. The multiplier 908 calculates the product of the output signal of the inverting amplification circuit 907 and the output signal of the low-pass filter 906. An output signal from the multiplier 908 is outputted to a terminal 909. The terminal 909 outputs the obtained signal as a tilt detection signal.

The output signal of the low-pass filter 906 indicates the polarity of the tilt of the optical disc, and the output signal from the detector circuit 905 mainly reflects the tilt amount of the optical disc. Accordingly, by determining the product of these, the direction and amount of the tilt are obtained.

However, in the conventional art described in Patent Literature 1, in the case where lens shift occurs, a DC component corresponding to the lens shift occurs in the low-pass filter. Since the DC component occurs irrespective of the tilt amount of the optical disc, an offset is generated in the output signal of the low-pass filter. The output signal of the low-pass filter is used mainly to obtain the polarity of the tilt detection signal, and a large error including an error in polarity may occur in the tilt detection signal due to the offset.

### CITATION LIST

### Patent Literature

Patent Literature 1: Japanese Patent Application Laid-open No. H8-36773

### SUMMARY OF THE INVENTION

The present invention has been achieved in order to solve the above problem, and an object thereof is to provide an optical information device, a tilt detection method, a computer, a player, and a recorder capable of accurately detecting the tilt amount of an optical information medium and reliably correcting the tilt of the optical information medium even when lens shift occurs.

An optical information device according to an aspect of the present invention includes a laser light source that emits a light flux, an objective lens that converges the light flux emitted from the laser light source on an optical information medium, a split element that splits the light flux reflected and diffracted on the optical information medium into a first light flux and a second light flux arranged side by side in a direction perpendicular to a tangent to a track of the optical information medium, a photodetector that receives the first light flux and the second light flux obtained by splitting by the split element, and outputs a first signal and a second signal corresponding to light amounts of the received first light flux and the received second light flux, a filter circuit that extracts a low band component of each of the first signal and the second signal outputted from the photodetector, and extracts a high band component of each of the first signal and the second signal outputted from the photodetector, an arithmetic circuit that generates a high band component difference signal as a difference between the high band component of the first signal extracted by the filter circuit and the high band component of the second signal extracted by the filter circuit and a low band component difference signal as a difference between the low band component of the first signal extracted by the filter circuit and the low band component of the second signal extracted by the filter circuit, adjusts a ratio between the generated high band component difference signal and the generated low band component difference signal, and calculates a difference signal between the high band component difference signal and the low band component difference signal between which the ratio is adjusted, a control signal processing section that generates a tilt control signal based on the difference signal calculated by the arithmetic circuit, and a drive mechanism that tilts the objective lens in a radial direction based on the tilt control signal generated by the control signal processing section.

According to the present invention, by calculating the difference signal between the high band component difference signal and the low band component difference signal, it is possible to reduce the amount of change of the tilt amount of the optical information medium caused by the lens shift, and it is possible to accurately detect the tilt amount of the optical information medium and reliably correct the tilt of the optical information medium even when the lens shift occurs. As a result, it is possible to reduce the coma aberration, and record or reproduce information at a low error rate.

Objects, features, and advantages of the present invention will become more apparent from the following detailed description and the accompanying drawings.

### BRIEF DESCRIPTION OF THE DRAWINGS

FIG. 1 is a diagrammatic view showing a configuration of an optical disc information device in a first embodiment of the present invention.

FIG. 2 is a view showing a frequency component of a signal of a first light receiving section and a frequency component of a signal of a second light receiving section in the case where radial tilt is not present.

FIG. 3 is a view showing the frequency component of the signal of the first light receiving section and the frequency component of the signal of the second light receiving section in the case where the radial tilt is +0.3 degrees.

FIG. 4 is a view showing the relationship between difference/sum ((PD1−PD2)/(PD1+PD2)) and a normalized frequency in the case where the radial tilt is 0 degrees.

FIG. 5 is a view showing the relationship between the difference/sum ((PD1−PD2)/(PD1+PD2)) and the normalized frequency in the case where the radial tilt is +0.3 degrees.

FIG. 6 is a view showing the relationship between the difference/sum ((PD1−PD2)/(PD1+PD2)) and the normalized frequency in the case where the radial tilt is −0.3 degrees.

FIG. 7 is a view showing the relationship between the difference/sum ((PD1−PD2)/(PD1+PD2)) and the normalized frequency in the case where the radial tilt is +0.7 degrees.

FIG. 8 is a view showing the relationship between the difference/sum ((PD1−PD2)/(PD1+PD2)) and the normalized frequency in the case where lens shift is +50 μm.

FIG. 9 is a view showing the relationship between the difference/sum ((PD1−PD2)/(PD1+PD2)) and the normalized frequency in the case where the lens shift is −50 μm.

FIG. 10 is a view showing the relationship between the radial tilt and a TLT signal.

FIG. 11 is a view showing the relationship between the lens shift and the TLT signal.

FIG. 12 is a diagrammatic view showing the configuration of the optical disc information device in a modification of the first embodiment of the present invention.

FIG. 13 is a flowchart for explaining a tilt detection method in the present embodiment.

FIG. 14 is a diagrammatic view showing the configuration of the optical disc information device in a second embodiment of the present invention.

FIG. 15 is a view showing an example of region split of a split element in the second embodiment of the present invention.

FIG. 16 is a view showing an example of region split of a split element in a first modification of the second embodiment of the present invention.

FIG. 17 is a view showing an example of the region split of the split element in a second modification of the second embodiment of the present invention.

FIG. 18 is a view showing an example of the region split of the split element in a third modification of the second embodiment of the present invention.

FIG. 19 is a perspective view showing a schematic configuration of a computer according to a third embodiment of the present invention.

FIG. 20 is a perspective view showing a schematic configuration of an optical disc player according to a fourth embodiment of the present invention.

FIG. 21 is a perspective view showing a schematic configuration of an optical disc recorder according to a fifth embodiment of the present invention.

FIG. 22 is a view showing a configuration of a photodetector as a conventional example.

### DESCRIPTION OF EMBODIMENTS

Hereinbelow, a description will be given of embodiments of the present invention with reference to the drawings. Note that each of the following embodiments is an example in which the present invention is embodied, and is not intended to limit the technical scope of the present invention.

### First Embodiment

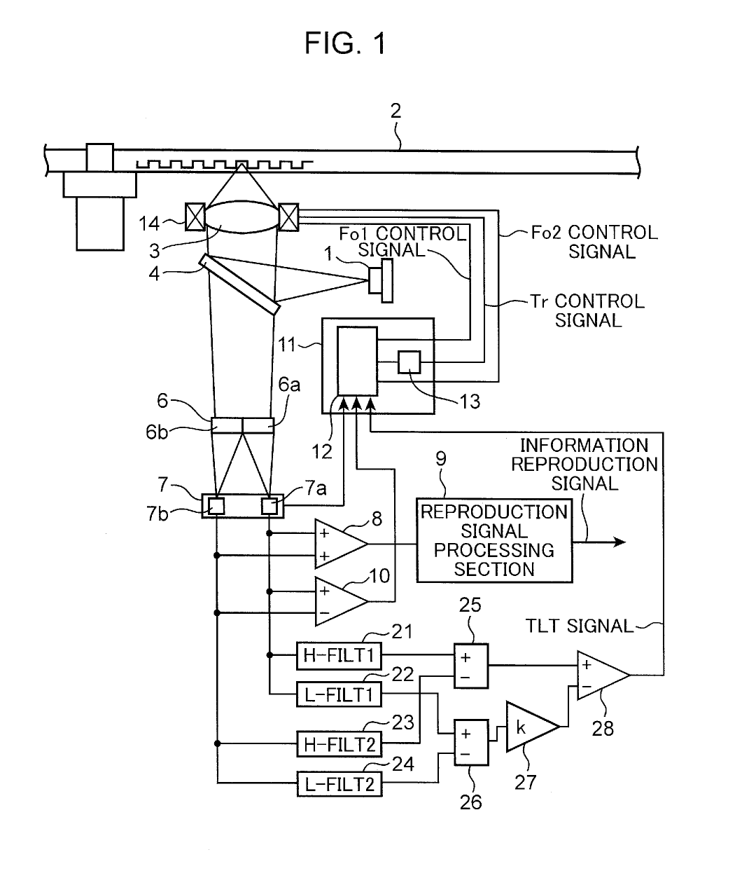

FIG. 1 is a diagrammatic view showing a configuration of an optical disc information device in a first embodiment of the present invention.

The optical disc information device shown in FIG. 1 includes a blue semiconductor laser 1, an objective lens 3, a laser mirror 4, a split element 6, a photodetector 7, an adding circuit 8, a reproduction signal processing section 9, a differential circuit 10, a control signal processing section 11, an objective lens actuator 14, a first high band extraction circuit 21, a first low band extraction circuit 22, a second high band extraction circuit 23, a second low band extraction circuit 24, a first normalization differential circuit 25, a second normalization differential circuit 26, an amplifier 27, and a differential circuit 28.

In FIG. 1, light having a wavelength of 400 nm to 415 nm is emitted from the blue semiconductor laser 1 as a laser light source. In the present first embodiment, the blue semiconductor laser 1 emits a light beam having a wavelength of approximately 405 nm. The light beam (light flux) emitted from the blue semiconductor laser 1 is reflected by the laser mirror 4 and travels toward the objective lens 3. The blue light beam narrowed by the objective lens 3 is emitted so as to be converged on, e.g., a groove portion on an information recording surface of an optical disc 2.

The numerical aperture of the objective lens 3 is 0.85. The objective lens 3 condenses the light beam having a wavelength of approximately 405 nm. The objective lens 3 converges the light flux emitted from the blue semiconductor laser 1 on the optical disc 2. Reflection light reflected and diffracted on the information recording surface of the optical disc 2 passes through the objective lens 3 similarly to its previous travel, passes through the laser mirror 4 and the beam splitter 5, and reaches the split element 6.

The split element 6 is a diffractive element produced so as to operate as a diffraction grating by forming fine grooves on its glass surface. The split element 6 is split into two portions in a direction corresponding to a radial direction R (a direction perpendicular to the tangent to a track) of the optical disc 2. The split element 6 includes a first region 6a and a second region 6b that are disposed adjacent to each other in the radial direction R of the optical disc 2. Light beams having passed through the individual regions of the split element 6 are separated by the diffraction gratings of the individual regions in different directions. The split element 6 splits the light flux reflected and diffracted on the optical disc 2 into a first light flux and a second light flux arranged side by side in the direction perpendicular to the tangent to the track of the optical disc 2.

The two light beams obtained by splitting by the split element 6 enter different light receiving sections of the photodetector 7. That is, the light beam having passed through the first region 6a enters a first light receiving section 7a of the photodetector 7, and the light beam having passed through the second region 6b enters a second light receiving section 7b thereof.

The photodetector 7 receives the first light flux and the second light flux obtained by splitting by the split element 6, and outputs a first signal and a second signal corresponding to the light amounts of the received first and second light fluxes. The first light receiving section 7a and the second light receiving section 7b of the photodetector 7 output the signals corresponding to the received light amounts. Although not shown in the drawing, current signals from the photodetector 7 are converted to voltage signals by an I-V amplifier. The signals outputted from the first light receiving section 7a and the second light receiving section 7b are inputted to the adding circuit 8. The adding circuit 8 generates a sum signal of the signal outputted from the first light receiving section 7a and the signal outputted from the second light receiving section 7b. The sum signal outputted from the adding circuit 8 is inputted to the reproduction signal processing section 9. The reproduction signal processing section 9 performs signal processing such as waveform equalization, decoding, and error correction on the inputted sum signal, and outputs the sum signal as an information reproduction signal.

The signals outputted from the first light receiving section 7a and the second light receiving section 7b are also inputted to the differential circuit 10. The differential circuit 10 calculates a difference signal between the signal outputted from the first light receiving section 7a and the signal outputted from the second light receiving section 7b. The signal from the differential circuit 10 is inputted to an arithmetic section 12 of the control signal processing section 11 as a push-pull signal corresponding to a tracking detection signal.

In addition, the signal outputted from the first light receiving section 7a is inputted to the first high band extraction circuit 21, and the signal outputted from the second light receiving section 7b is inputted to the second high band extraction circuit 23. The first high band extraction circuit 21 receives the signal from the first light receiving section 7a, and outputs a signal proportional to the high band component of the signal from the first light receiving section 7a. Similarly, the second high band extraction circuit 23 receives the signal from the second light receiving section 7b, and outputs a signal proportional to the high band component of the signal from the second light receiving section 7b. The first high band extraction circuit 21 extracts the high band component of the first signal outputted from the photodetector 7, while the second high band extraction circuit 23 extracts the high band component of the second signal outputted from the photodetector 7.

Further, the signal outputted from the first light receiving section 7a is inputted to the first low band extraction circuit 22, and the signal outputted from the second light receiving section 7b is inputted to the second low band extraction circuit 24. The first low band extraction circuit 22 receives the signal from the first light receiving section 7a, and outputs a signal proportional to the low band component of the signal from the first light receiving section 7a. Similarly, the second low band extraction circuit 24 receives the signal from the second light receiving section 7b, and outputs a signal proportional to the low band component of the signal from the second light receiving section 7b. The first low band extraction circuit 22 extracts the low band component of the first signal outputted from the photodetector 7, while the second low band extraction circuit 24 extracts the low band component of the second signal outputted from the photodetector 7.

The first normalization differential circuit 25 receives the output of the first high band extraction circuit 21 and the output of the second high band extraction circuit 23, and calculates and outputs a normalized difference signal as a value obtained by dividing the difference between the output of the first high band extraction circuit 21 and the output of the second high band extraction circuit 23 by the sum of the output of the first high band extraction circuit 21 and the output of the second high band extraction circuit 23. An output signal from the first normalization differential circuit 25 represents a difference between the high band components included in the signals from the two light receiving sections. The first normalization differential circuit 25 generates a high band component difference signal as the difference between the high band component of the first signal extracted by the first high band extraction circuit 21 and the high band component of the second signal extracted by the second high band extraction circuit 23.

In addition, the second normalization differential circuit 26 receives the output of the first low band extraction circuit 22 and the output of the second low band extraction circuit 24, and calculates and outputs a normalized difference signal as a value obtained by dividing the difference between the output of the first low band extraction circuit 22 and the output of the second low band extraction circuit 24 by the sum of the output of the first low band extraction circuit 22 and the output of the second low band extraction circuit 24. An output signal from the second normalization differential circuit 26 represents a difference between the low band components included in the signals from the two light receiving sections. The second normalization differential circuit 26 generates a low band component difference signal as the difference between the low band component of the first signal extracted by the first low band extraction circuit 22 and the low band component of the second signal extracted by the second low band extraction circuit 24.

The amplifier 27 receives the output signal of the second normalization differential circuit 26, and outputs a signal obtained by multiplying the inputted signal by a constant k. The amplifier 27 adjusts the ratio between the generated high band component difference signal and the generated low band component difference signal.

The differential circuit 28 receives the output of the first normalization differential circuit 25 and the output of the amplifier 27, calculates a difference signal between the output of the first normalization differential circuit 25 and the output of the amplifier 27, and outputs the calculated differential signal as a TLT signal. The signal outputted from the differential circuit 28 represents a difference between the difference between the high band components and the value obtained by multiplying the difference between the low band components by the constant. The signal outputted from the differential circuit 28 is significantly changed when an increase and a decrease in each of the high band component and the low band component are inversely changed in each region. The differential circuit 28 calculates the difference signal between the high band component difference signal and the low band component difference signal between which the ratio is adjusted.

The difference signal outputted from the differential circuit 28 is inputted to the arithmetic section 12 of the control signal processing section 11 as a tilt detection signal. In addition, although not shown in the drawing, a focus error signal is generated from the signal from the photodetector 7, and is inputted to the arithmetic section 12 of the control signal processing section 11.

The control signal processing section 11 generates a tilt control signal based on the difference signal calculated by the differential circuit 28. The control signal processing section 11 includes the arithmetic section 12 and a tracking switcher 13.

Upon reception of the inputted signal, the arithmetic section 12 outputs a tracking control signal of one system (a Tr control signal) and focus control signals of two systems (a Fo1 control signal and a Fo2 control signal). The tracking control signal is inputted to the objective lens actuator 14. The objective lens actuator 14 moves the objective lens 3 in the radial direction in accordance with the tracking control signal. The control signal processing section 11 includes the tracking switcher 13. The tracking switcher 13 inverts the polarity of the tracking control signal in accordance with whether the track scanned with a condensing spot is a land portion or a groove portion of the optical disc 2.

The focus control signals of two systems are inputted to the objective lens actuator 14. The objective lens actuator 14 generates a driving force for translating the objective lens 3 in a direction of an optical axis, and a driving force for rotating the objective lens 3 in the radial direction in accordance with the focus control signals of two systems. For example, it is assumed that the Fo1 control signal of the focus control signals of two systems is inputted to a right actuator, and the Fo2 control signal is inputted to a left actuator. At this point, the objective lens 3 is translated in the direction of the optical axis in the case where the focus control signals of two systems are equal to each other, and the objective lens 3 is tilted in accordance with a difference between the focus control signals when the focus control signals of two systems are different from each other. The objective lens actuator 14 tilts the objective lens 3 in the radial direction based on the tilt control signal (the focus control signals of two systems) generated by the control signal processing section 11.

Note that, in the present embodiment, the blue semiconductor laser 1 corresponds to an example of a laser light source, the objective lens 3 corresponds to an example of an objective lens, the split element 6 corresponds to an example of a split element, the photodetector 7 corresponds to an example of a photodetector, each of the first high band extraction circuit 21, the first low band extraction circuit 22, the second high band extraction circuit 23, and the second low band extraction circuit 24 corresponds to an example of a filter circuit, each of the first normalization differential circuit 25, the second normalization differential circuit 26, the amplifier 27, and the differential circuit 28 corresponds to an example of an arithmetic circuit, the control signal processing section 11 corresponds to an example of a control signal processing section, and the objective lens actuator 14 corresponds to an example of a drive mechanism.

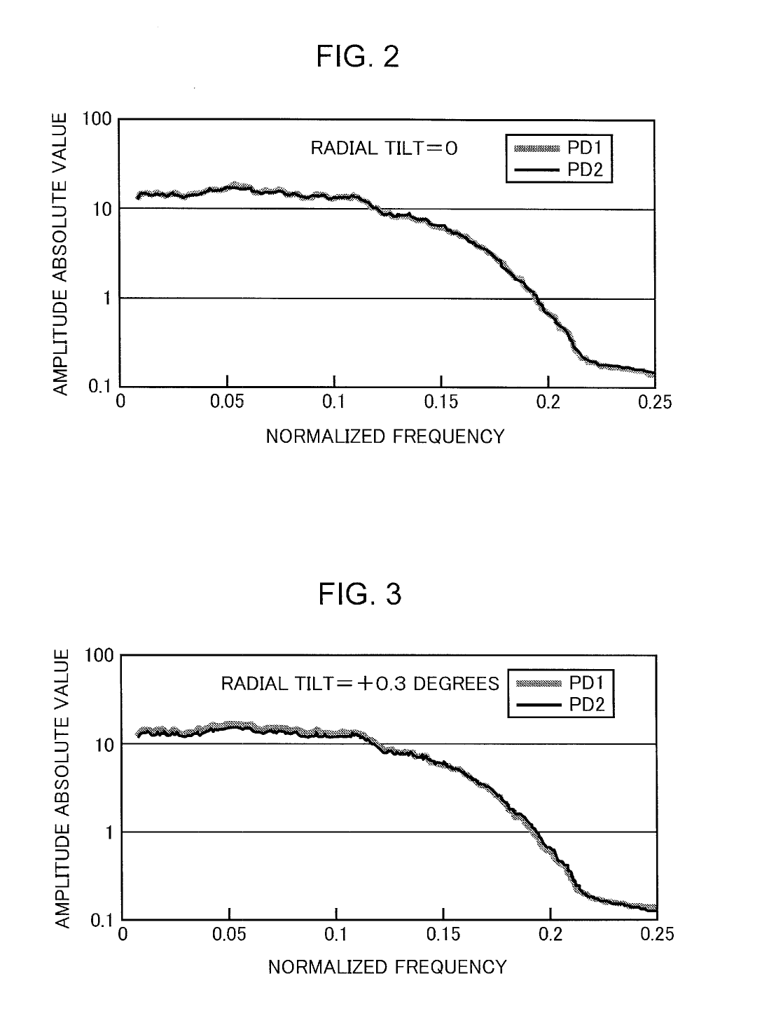

Each of FIG. 2 and FIG. 3 shows the result of frequency analysis carried out by performing Fourier transformation on each signal obtained from each light receiving section in the case where radial tilt is present. Herein, the numerical aperture (NA) of the optical system is set to 0.85, the wavelength 2 of the light beam is set to 405 nm, the length of 1T (channel clock) of a recording mark is set to 55.78 nm, and a normalized frequency is defined such that the frequency of 1T is 1. For example, repetition of 2T space and 2T mark is a signal having a period of 4T, and its normalized frequency is 0.25 (=¼).

FIG. 2 is a view showing the frequency component of the signal of the first light receiving section and the frequency component of the signal of the second light receiving section in the case where the radial tilt is not present. In FIG. 2, the horizontal axis indicates the normalized frequency, while the vertical axis indicates the amplitude of the frequency component using a logarithmic scale. In the case where the radial tilt is not present, a signal PD1 from the first light receiving section and a signal PD2 from the second light receiving section are substantially the same.

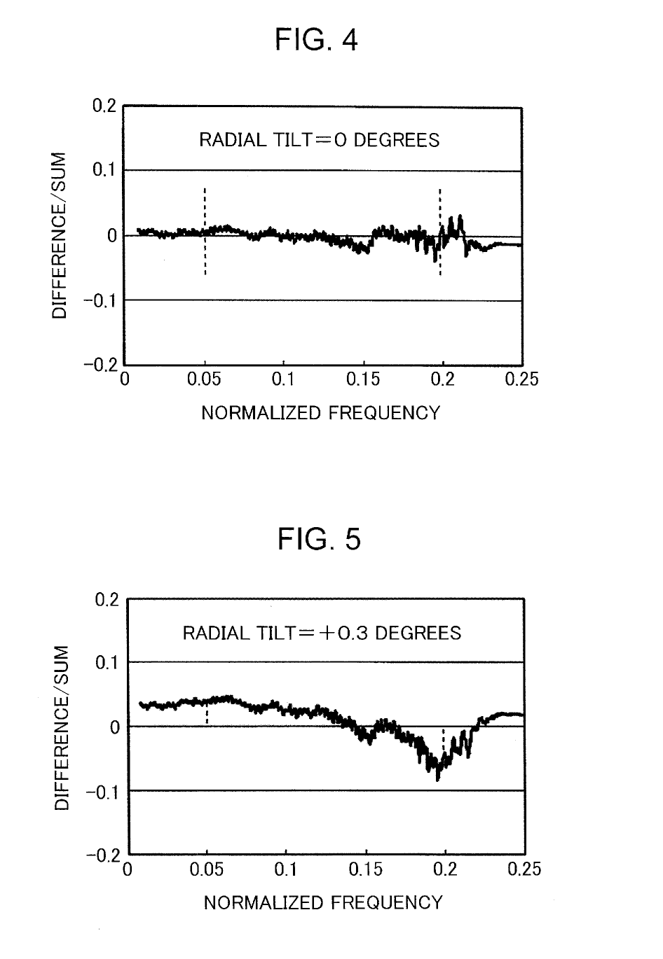

FIG. 3 is a view showing the frequency component of the signal of the first light receiving section and the frequency component of the signal of the second light receiving section in the case where the radial tilt is +0.3 degrees. A difference is generated between the signal PD1 from the first light receiving section and the signal PD2 from the second light receiving section. In a low frequency band (the normalized frequency=the vicinity of 0.05), the signal PD1 is larger than the signal PD2. On the other hand, in a high frequency band (the normalized frequency=the vicinity of 0.2), the signal PD2 is larger than the signal PD1. Each of FIGS. 4 to 7 shows a graph in which (PD1−PD2)/(PD1+PD2) is calculated as a difference obtained by normalizing the difference between the signal PD1 and the signal PD2.

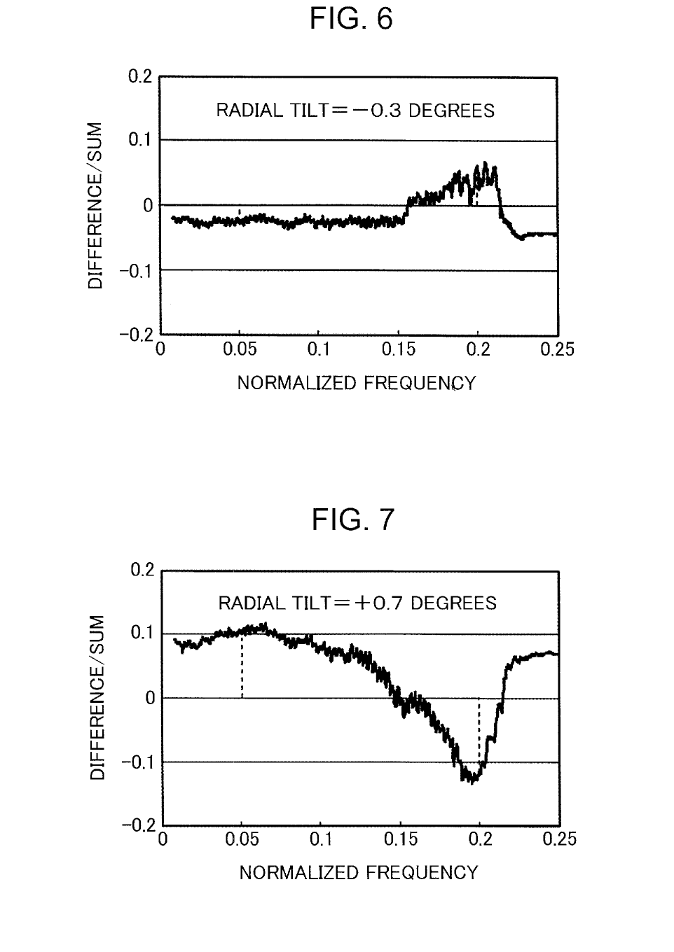

FIG. 4 is a view showing the relationship between difference/sum ((PD1−PD2)/(PD1+PD2)) and the normalized frequency in the case where the radial tilt is 0 degrees. FIG. 5 is a view showing the relationship between the difference/sum ((PD1−PD2)/(PD 1+PD2)) and the normalized frequency in the case where the radial tilt is +0.3 degrees. FIG. 6 is a view showing the relationship between the difference/sum ((PD1−PD2)/(PD1+PD2)) and the normalized frequency in the case where the radial tilt is −0.3 degrees. FIG. 7 is a view showing the relationship between the difference/sum ((PD1−PD2)/(PD 1+PD2)) and the normalized frequency in the case where the radial tilt is +0.7 degrees.

In FIG. 4, in the case where the radial tilt is not present, the difference/sum has a value in the vicinity of 0 over the entire band of the normalized frequency. In FIG. 5, in the case where the radial tilt is +0.3 degrees, the difference/sum displays a positive change in the low frequency band (0.05), and displays a negative change in the high frequency band (0.2). In FIG. 6, in the case where the radial tilt is −0.3 degrees, the difference/sum displays the negative change in the low frequency band (0.05), and displays the positive change in the high frequency band (0.2). In FIG. 7, in the case where the radial tilt is +0.7 degrees, the difference/sum displays the positive change in the low frequency band (0.05), and displays the negative change in the high frequency band (0.2). The change amount in the case where the radial tilt is +0.7 degrees is not less than twice the change amount in the case where the radial tilt is +0.3 degrees. Thus, the low band component, the high band component, and the polarities are changed by the radial tilt, and the change amount is changed in accordance with the tilt amount.

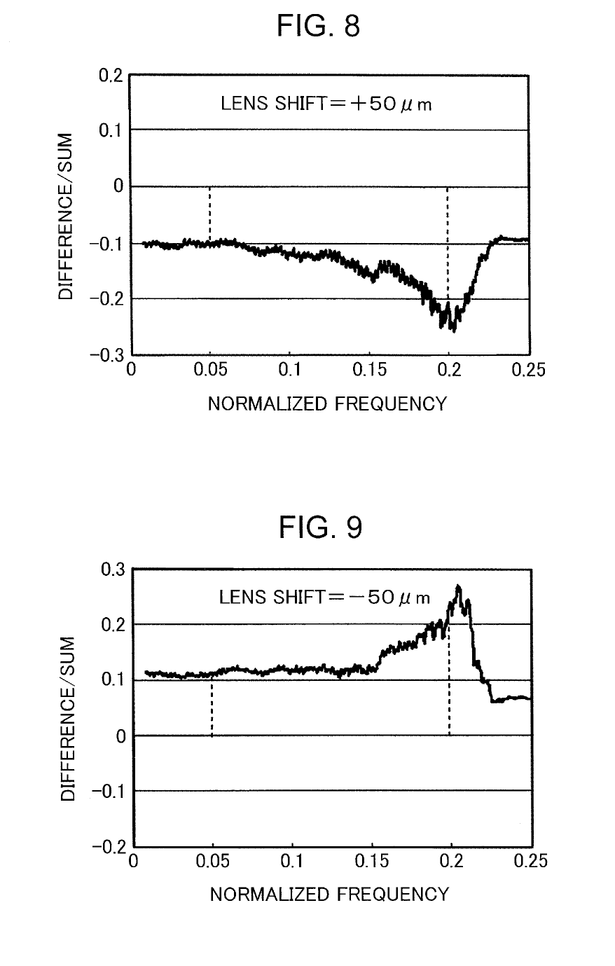

On the other hand, each of FIGS. 8 and 9 shows the difference/sum ((PD1−PD2)/(PD1+PD2)) in the case where lens shift has occurred. FIG. 8 is a view showing the relationship between the difference/sum ((PD1−PD2)/(PD 1+PD2)) and the normalized frequency in the case where the lens shift is +50 μm. FIG. 9 is a view showing the relationship between the difference/sum ((PD1−PD2)/(PD1+PD2)) and the normalized frequency in the case where the lens shift is −50 μm.

As shown in FIGS. 8 and 9, in the case where the lens shift is present, the difference/sum is changed on the same polarity side in the vicinity of the low frequency band (0.05) and in the vicinity of the high frequency band (0.2). In addition, the change in the high frequency band (0.2) is twice the change in the low frequency band (0.05). Consequently, the TLT signal is represented by the following arithmetic expression by using a change amount AH in the high frequency band (0.2) and a change amount ΔL in the low frequency band (0.05) and, when a coefficient k=2 is established, the amount of change of the TLT signal caused by the lens shift can be made substantially equal to zero.

TLT signal=ΔH−k·ΔL

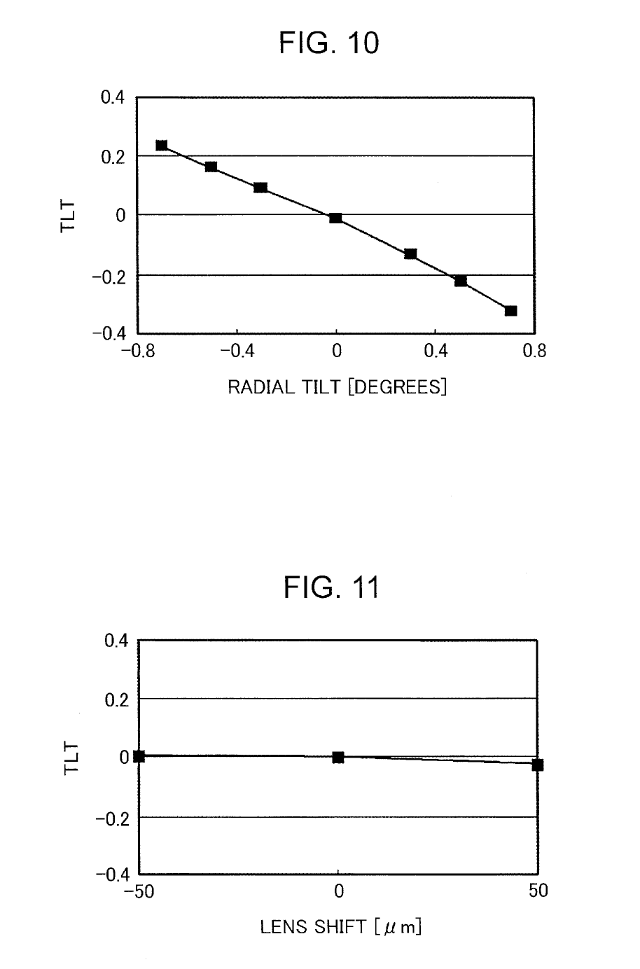

FIG. 10 is a view showing the relationship between the radial tilt and the TLT signal. In FIG. 10, the horizontal axis indicates the radial tilt, and the vertical axis indicates the TLT signal. As shown in the drawing, it is possible to obtain the TLT signal corresponding to the radial tilt. FIG. 11 is a view showing the relationship between the lens shift and the TLT signal. In FIG. 11, the horizontal axis indicates the lens shift, and the vertical axis indicates the TLT signal. The change of the TLT signal caused by the lens shift is extremely small. With the arithmetic operation of such a TLT signal, it is possible to obtain the tilt detection signal that is not changed by the lens shift and has a sensitivity only to the radial tilt.

In the case where the tilt of the objective lens actuator is controlled by using the tilt detection signal described above, even when the tilt of the optical disc is present, it is possible to prevent the occurrence of a coma aberration, and record or reproduce a signal having a low error rate.

The control signal processing section 11 includes the tracking switcher 13. The tracking switcher 13 inverts the polarity of the tracking control signal in accordance with whether the track scanned with the condensing spot is the land portion or the groove portion of the optical disc 2.

Herein, although the horizontal axis is represented as the normalized frequency, since the optical disc is actually rotated at a predetermined linear speed or RPM, the characteristic shown herein is displayed as the frequency of the signal. For example, when a mark string with 1T of 55.78 nm is assumed and the optical disc is assumed to be rotated at a linear speed of 7.4 m/sec, transit time of 1T is 7.54 nsec. The frequency of the mark string having a period of 4T with repetition of 2T mark and 2T space corresponds to 33 MHz. The normalized frequency of 0.2 corresponds to about 26.4 MHz, and the normalized frequency of 0.05 corresponds to about 6.6 MHz.

Thus, when the frequency normalized such that the frequency of one channel clock is 1 is defined as the normalized frequency, the low band component includes the frequency component corresponding to the normalized frequency of 0.05, and the high band component includes the frequency component corresponding to the normalized frequency of 0.2.

Note that, although the present embodiment shows the example in which the light beam is split by split element 6 and the individual light beams obtained by the splitting are received by the two light receiving sections, one light beam may be received by a four split light receiving section that is split into the shape of a cross. In this case, the photodetector and detection regions function as the split element. From the combination of arithmetic operations for obtaining the push-pull signal from the photodetector having such a four split light receiving section, the signal corresponding to the signal from the first light receiving section 7a and the signal corresponding to the signal from the second light receiving section 7b may be generated.

Note that the amplifier that performs the multiplication using the coefficient is provided on the side of the low band extraction circuit, the amplifier may also be provided on the side of the high band extraction circuit. In this case, the amplifier provided on the side of the high band extraction circuit can obtain a proper tilt signal by performing multiplication using a reciprocal of the coefficient used in the amplifier provided on the side of the low band extraction circuit. In addition, although the value of the proper coefficient k assumed in the present embodiment is 2, the value of the proper coefficient k may be a value different from 2 depending on parameters of the optical head (the diameter of the objective lens, the peripheral intensity of the light beam, the numerical aperture, the track pitch, and the shapes of the first region and the second region of the split element 6). Also in this case, the value of the coefficient k may be appropriately determined such that the sensitivity to the lens shift becomes zero.

In addition, although the normalized frequency corresponding to the high band component is 0.2 and the normalized frequency corresponding to the low band component is 0.05 in the present embodiment, the present invention is not limited thereto, and the normalized frequency may also be changed to a proper normalized frequency in accordance with the parameters of the optical head. At this point, it is preferable to select the combination of the normalized frequency of the high band component and the normalized frequency of the low band component that maximizes the change of the radial tilt.

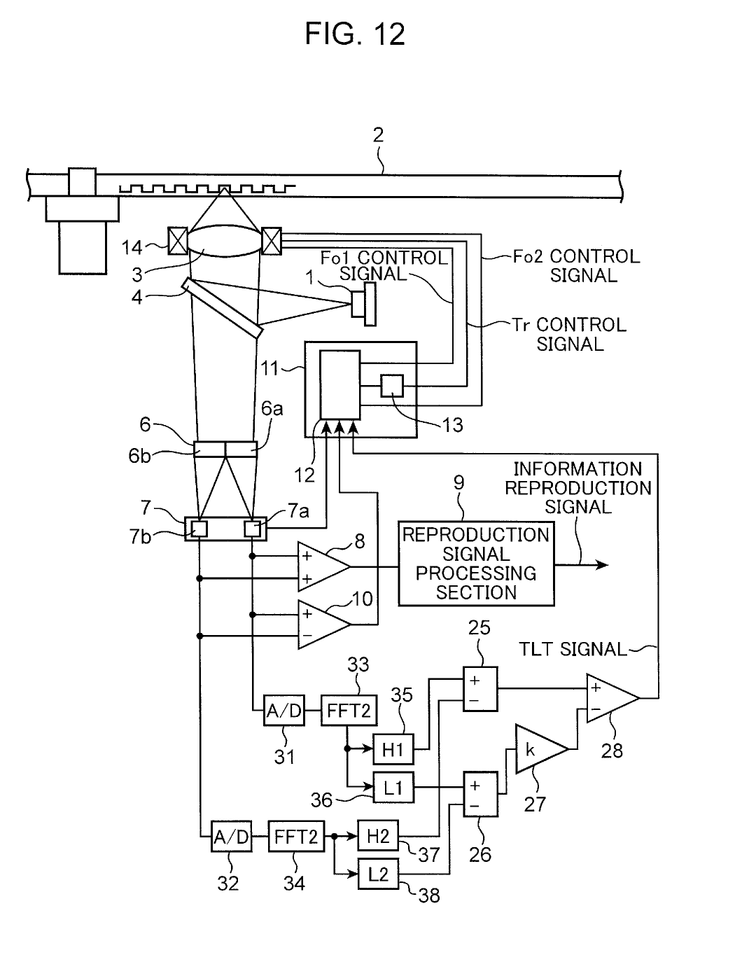

Note that, although the optical disc information device in the present embodiment is provided with the high band extraction circuits (the first high band extraction circuit 21 and the second high band extraction circuit 23) and the low band extraction circuits (the first low band extraction circuit 22 and the second low band extraction circuit 24), the present invention is not limited thereto, and the low band component and the high band component may also be calculated by capturing a digital signal obtained by A/D conversion into a memory and performing Fourier transformation on the digital signal using software. FIG. 12 shows an example of the configuration in that case.

FIG. 12 is a diagrammatic view showing the configuration of the optical disc information device in a modification of the first embodiment of the present invention.

The optical disc information device shown in FIG. 12 includes the blue semiconductor laser 1, the objective lens 3, the laser mirror 4, the split element 6, the photodetector 7, the adding circuit 8, the reproduction signal processing section 9, the differential circuit 10, the control signal processing section 11, the objective lens actuator 14, the first normalization differential circuit 25, the second normalization differential circuit 26, the amplifier 27, the differential circuit 28, an A/D converter 31, an A/D converter 32, a first Fourier transformer 33, a second Fourier transformer 34, a first high band component extractor 35, a first low band component extractor 36, a second high band component extractor 37, and a second low band component extractor 38.

The signals from the first light receiving section 7a and the second light receiving section 7b are inputted to the A/D converter 31 and the A/D converter 32. The A/D converter 31 and the A/D converter 32 convert analog signals to digital signals. The digital signals outputted from the A/D converter 31 and the A/D converter 32 are inputted to the first Fourier transformer 33 and the second Fourier transformer 34. The first Fourier transformer 33 and the second Fourier transformer 34 convert inputted time-series signals to frequency-series signals.

Each of the first high band component extractor 35 and the second high band component extractor 37 selects the value of the high frequency component from the frequency-series signal obtained by the transformation by each of the first Fourier transformer 33 and the second Fourier transformer 34, and retains the value thereof. Each of the first high band component extractor 35 and the second high band component extractor 37 outputs the retained value of the high frequency component. In addition, each of the first low band component extractor 36 and the second low band component extractor 38 selects the value of the low frequency component from the frequency-series signal obtained by the transformation by each of the first Fourier transformer 33 and the second Fourier transformer 34, and retains the value thereof. Each of the first low band component extractor 36 and the second low band component extractor 38 outputs the retained value of the low frequency component.

The first normalization differential circuit 25 receives the values from the first high band component extractor 35 and the second high band component extractor 37, and calculates and outputs a normalized difference signal as a value obtained by dividing a difference between the value from the first high band component extractor 35 and the value from the second high band component extractor 37 by a sum of the value from the first high band component extractor 35 and the value from the second high band component extractor 37.

The second normalization differential circuit 26 receives the values from the first low band component extractor 36 and the second low band component extractor 38, and calculates and outputs a normalized difference signal as a value obtained by dividing a difference between the value from the first low band component extractor 36 and the value from the second low band component extractor 38 by a sum of the value from the first low band component extractor 36 and the value from the second low band component extractor 38. The amplifier 27 receives an output signal of the second normalization differential circuit 26, and outputs a signal obtained by multiplying the inputted signal by the constant k.

The differential circuit 28 receives the output of the first normalization differential circuit 25 and the output of the amplifier 27, calculates a difference signal between the output of the first normalization differential circuit 25 and the output of the amplifier 27, and outputs the calculated difference signal as the TLT signal. Herein, although each of the first normalization differential circuit 25, the second normalization differential circuit 26, the amplifier 27, and the differential circuit 28 is configured by the circuit, a configuration may also be adopted in which the signal represented by a digital value is calculated using software and, in this case as well, the same effect as, that in the case where it is configured by the circuit is obtained. The signal obtained from the differential circuit 28 is transferred to the control signal processing section 11 as the digital value, and the control signal is calculated. Subsequently, the control signal as the digital value may be appropriately converted to the analog signal at a stage where driving power of the objective lens actuator 14 is obtained.

Although a detection method of the focus control signal is not described in detail, the focus control signal may be detected by a spot size method by causing diffracted light to have a power (condensing power) when the light beam is split by the split element 6. In addition, the focus control signal may also be detected by an astigmatic method by reflecting part of the light beam entering the split element 6, giving astigmatism to the reflected light beam, and causing the four split light receiving section to receive the light beam.

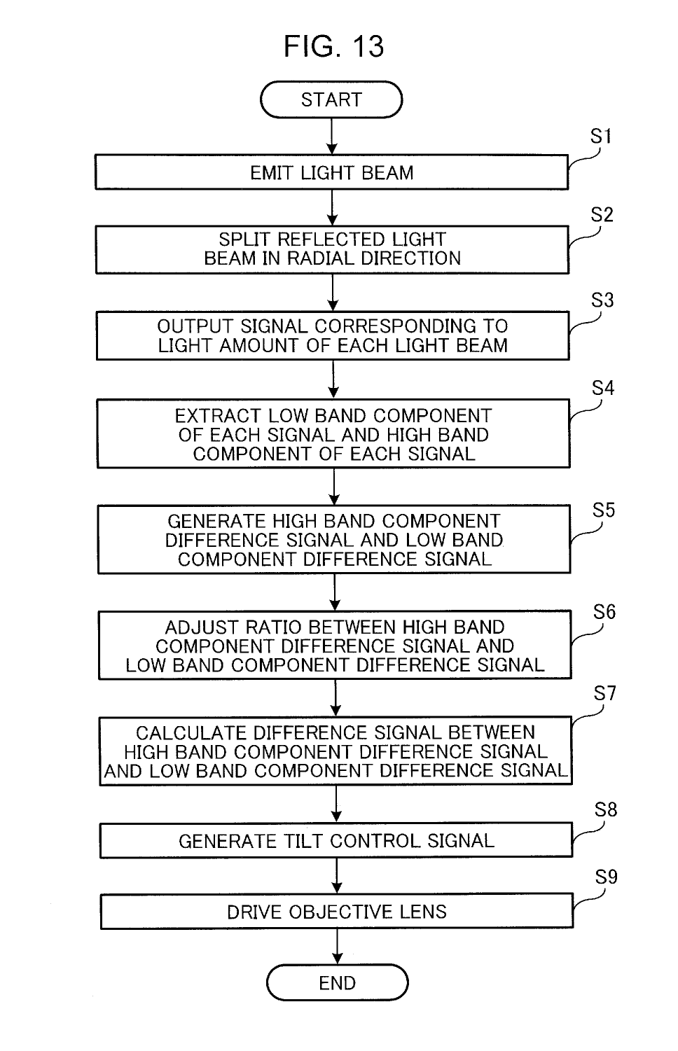

A tilt detection method in the present embodiment will be described by using FIG. 13. FIG. 13 is a flowchart for explaining the tilt detection method in the embodiment.

First, the blue semiconductor laser 1 emits the light beam (Step S1). The light beam emitted from the blue semiconductor laser 1 is reflected by the laser mirror 4, and is condensed on the information recording surface of the optical disc 2 by the objective lens 3. The light beam reflected on the information recording surface of the optical disc 2 passes through the laser mirror 4, and enters the split element 6.

Next, the split element 6 splits the light beam (light flux) reflected on the optical disc into the first light beam and the second light beam arranged side by side in the radial direction perpendicular to the tangent to the track (Step S2). The first light beam and the second light beam obtained by the splitting enter the first light receiving section 7a and the second light receiving section 7b of the photodetector 7.

Next, the first light receiving section 7a receives the first light beam obtained by the splitting by the split element 6 and outputs the first signal corresponding to the light mount of the received first light beam, and the second light receiving section 7b receives the second light beam obtained by the splitting by the split element 6 and outputs the second signal corresponding to the light amount of the received second light beam (Step S3).

Next, the first low band extraction circuit 22 extracts the low band component of the first signal outputted from the first light receiving section 7a, the second low band extraction circuit 24 extracts the low band component of the second signal outputted from the second light receiving section 7b, the first high band extraction circuit 21 extracts the high band component of the first signal outputted from the first light receiving section 7a, and the second high band extraction circuit 23 extracts the high band component of the second signal outputted from the second light receiving section 7b (Step S4).

Next, the first normalization differential circuit 25 generates the high band component difference signal as the difference between the high band component of the first signal extracted by the first high band extraction circuit 21 and the high band component of the second signal extracted by the second high band extraction circuit 23, and the second normalization differential circuit 26 generates the low band component difference signal as the difference between the low band component of the first signal extracted by the first low band extraction circuit 22 and the low band component of the second signal extracted by the second low band extraction circuit 24 (Step S5).

Next, the amplifier 27 adjusts the ratio between the generated high band component difference signal and the generated low band component difference signal by multiplying the low band component difference signal by the predetermined coefficient k (Step S6).

Next, the differential circuit 28 calculates the difference signal between the high band component difference signal and the low band component difference signal between which the ratio is adjusted (Step S7). The differential circuit 28 calculates the TLT signal proportional to the radial tilt. The difference signal subjected to subtraction by the differential circuit 28 is outputted as the TLT signal. The TLT signal is used for performing tilt control of the objective lens 3.

Next, the control signal processing section 11 generates the tilt control signal based on the difference signal calculated by the differential circuit 28 (Step S8). Note that the tilt control signal is configured by the Fo1 control signal and the Fo2 control signal.

Next, the objective lens actuator 14 tilts the objective lens 3 in the radial direction based on the tilt control signal (the Fo1 control signal and the Fo2 control signal) generated by the control signal processing section 11 (Step S9).

Note that, in the present embodiment, although the differential circuit 28 calculates the TLT signal by using the normalized difference signal obtained by dividing the difference between the output of the first high band extraction circuit 21 and the output of the second high band extraction circuit 23 by the sum of the output of the first high band extraction circuit 21 and the output of the second high band extraction circuit 23, the present invention is not particularly limited thereto, and the differential circuit 28 may also calculate the TLT signal by using the difference signal between the output of the first high band extraction circuit 21 and the output of the second high band extraction circuit 23. In addition, although the differential circuit 28 calculates the TLT signal by using the normalized difference signal obtained by dividing the difference between the output of the first low band extraction circuit 22 and the output of the second low band extraction circuit 24 by the sum of the output of the first low band extraction circuit 22 and the output of the second low band extraction circuit 24, the present invention is not particularly limited thereto, and the differential circuit 28 may also calculate the TLT signal by using the difference signal between the output of the first low band extraction circuit 22 and the output of the second low band extraction circuit 24. In this case, the value significantly differs between the high band component and the low band component, and hence it is preferable to multiply one of the difference signal of the high band component and the difference signal of the low band component by a proper correction coefficient to equalize the respective levels of the signals.

### Second Embodiment

In a second embodiment, an example in which tilt correction and crosstalk cancel are combined will be described. Note that components which are the same as those in the first embodiment are designated by the same reference numerals, and the detailed description thereof will be omitted.

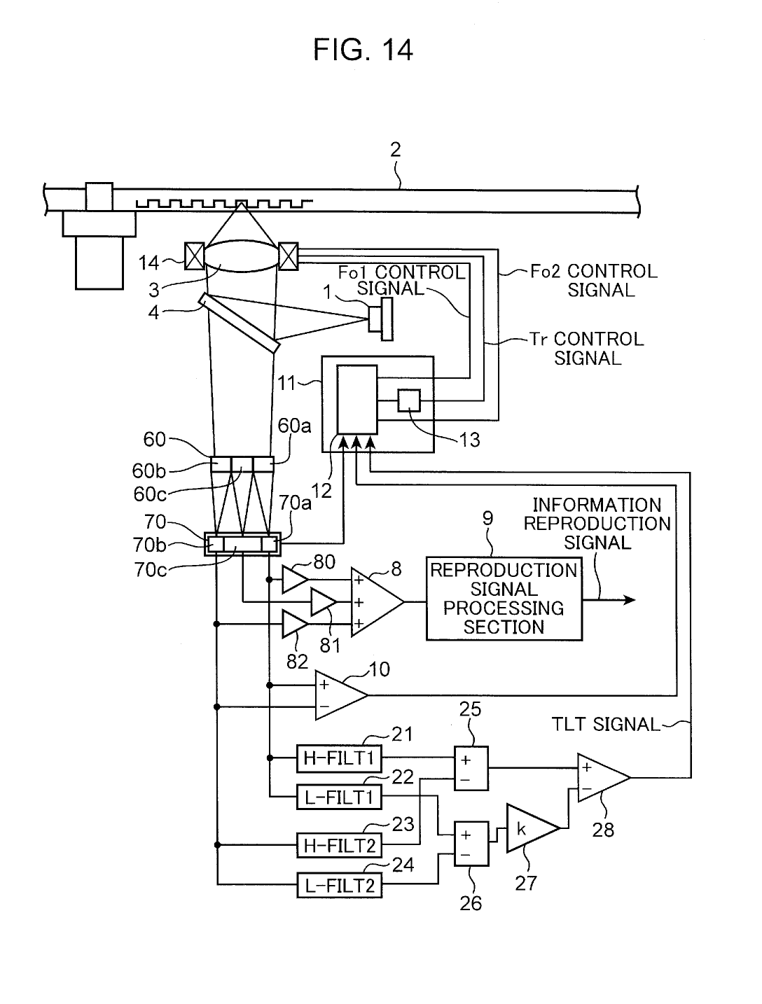

FIG. 14 is a diagrammatic view showing the configuration of the optical disc information device of the second embodiment of the present invention. The second embodiment is different from the first embodiment in that a split element 60 split into three portions is used in place of the split element 6 split into two portions.

The optical disc information device shown in FIG. 14 includes the blue semiconductor laser 1, the objective lens 3, the laser mirror 4, the split element 60, a photodetector 70, the adding circuit 8, the reproduction signal processing section 9, the differential circuit 10, the control signal processing section 11, the objective lens actuator 14, the first high band extraction circuit 21, the first low band extraction circuit 22, the second high band extraction circuit 23, the second low band extraction circuit 24, the first normalization differential circuit 25, the second normalization differential circuit 26, the amplifier 27, the differential circuit 28, an amplifier 80, an amplifier 81, and an amplifier 82.

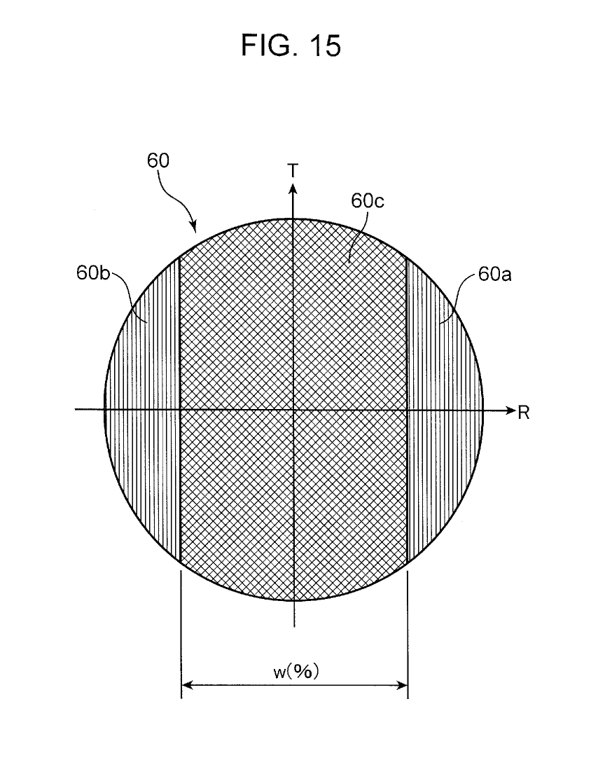

FIG. 15 is a view showing an example of region split of the split element 60 in the second embodiment of the present invention.

The split element 60 is split into three regions of a center region 60c, a first end region 60a, and a second end region 60b in the direction (a direction of an arrow R in FIG. 15) perpendicular to the direction of the tangent to the track (a direction of an arrow T in FIG. 15). The first end region 60a as a first region and the second end region 60b as a second region are disposed so as to be symmetrical with each other relative to a straight line parallel with the tangent to the track and passing through the center of an opening.

That is, the split element 60 includes the center region 60c including the center of the split element 60 (optical axis), the first end region 60a disposed adjacent to the center region 60c in the direction perpendicular to the tangent to the track, and the second end region 60b disposed to be symmetrical with the first end region 60a relative to an axis corresponding to a straight line passing through the center of the split element 60 (optical axis) and parallel with the tangent to the track. Note that, in the present second embodiment, a width w of the center region 60c of the split element 60 in the radial direction R is set to about 35% of the diameter of the light beam.

Three light beams (light fluxes) obtained by splitting by the split element 60 are received by the photodetector 70. The photodetector 70 includes a first light receiving section 70a, a second light receiving section 70b, and a third light receiving section 70c. The first light receiving section 70a receives the light beam having passed through the first end region 60a, the second light receiving section 70b receives the light beam having passed through the second end region 60b, and the third light receiving section 70c receives the light beam having passed through the center region 60c. The light beams received by the first light receiving section 70a, the second light receiving section 70b, and the third light receiving section 70c are converted to current signals corresponding to the light amounts thereof. Further, the current signals are converted to voltage signals by an I-V amplifier (not shown).

A signal outputted from the first light receiving section 70a is inputted to the amplifier 80 and multiplied by a specific multiplying factor. A signal outputted from the second light receiving section 70b is inputted to the amplifier 82 and multiplied by a specific multiplying factor. A signal outputted from the third light receiving section 70c is inputted to the amplifier 81 and multiplied by a specific multiplying factor. The multiplying factors of the amplifiers 80, 81, and 82 are determined such that an effect of reducing crosstalk is enhanced. When each of the multiplying factors of the amplifiers 80 and 82 is about three times to five times the multiplying factor of the amplifier 81, the effect of the crosstalk is enhanced. Signals outputted from the amplifiers 80, 81, and 82 are added up by the adding circuit 8. The adding circuit 8 outputs a sum signal obtained by adding up the signals outputted from the amplifiers 80, 81, and 82.

On the other hand, the signals outputted from the first light receiving section 70a and the second light receiving section 70b are inputted to the differential circuit 10. The differential circuit 10 detects a signal similar to the push-pull signal. The tracking signal (Tr control signal) is obtained based on this signal.

In addition, the signal outputted from the first light receiving section 70a is inputted to the first high band extraction circuit 21 and the first low band extraction circuit 22, and the signal outputted from the second light receiving section 70b is inputted to the second high band extraction circuit 23 and the second low band extraction circuit 24. Note that the configurations of arithmetic circuits subsequent to the first high band extraction circuit 21, the first low band extraction circuit 22, the second high band extraction circuit 23, and the second low band extraction circuit 24 are the same as those of the first embodiment, and hence the description thereof will be omitted.

Even with the configuration of the present second embodiment, the change to the radial tilt and the change to the lens shift of the high band component and the low band component of each of the signals corresponding to the light amounts of the light beams having passed through the first end region 60a and the second end region 60b show substantially the same tendencies as those of the characteristics shown in FIGS. 2 to 11. Consequently, even with the split pattern in the present second embodiment, it is possible to detect the radial tilt without influence of the lens shift. In addition, with the configuration of the present second embodiment, it is possible to detect the tilt and reduce the crosstalk amount at the same time.

Herein, other split patterns of the split element will be described.

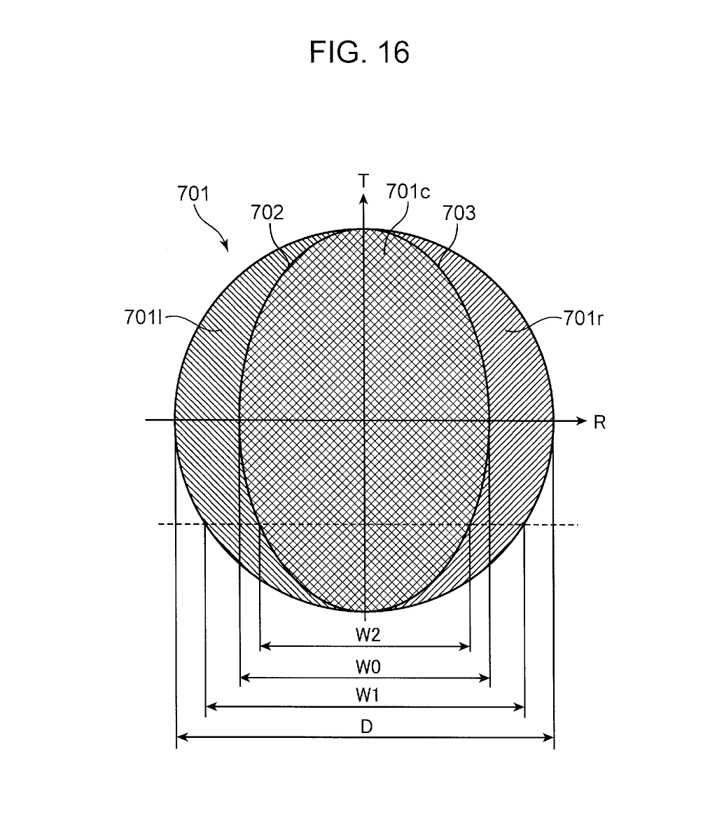

FIG. 16 is a view showing an example of the region split of the split element in a first modification of the second embodiment of the present invention. The optical system is the same as that shown in the second embodiment, and a split element 701 is used in place of the split element 60.

The split element 701 is split into a first end region 701r, a center region 701c, and a second end region 7011 by a splitting line 702 and a splitting line 703. Each of the splitting lines 702 and 703 is an outwardly convex curve. At each position in a tangential direction (T-axis direction) as the direction of the tangent to the track, the ratio among the widths of the first end region 701r, the center region 701c, and the second end region 7011 is constant. That is, the positions of the splitting lines 702 and 703 are determined such that a ratio W0/D of a width W0 of the center region 701c relative to a diameter D of the light beam at the center of the split element 701 (the optical axis) in the tangential direction T is equal to a ratio W2/W1 of a width W2 of the center region 701c relative to a width W1 of the contour of the light beam at any position in the tangential direction T.

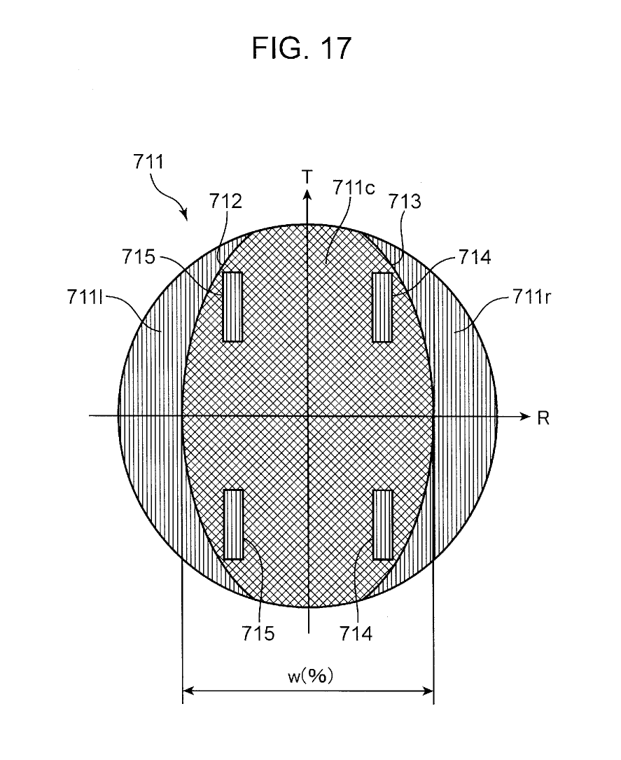

FIG. 17 is a view showing an example of the region split of the split element in a second modification of the second embodiment of the present invention. The optical system is the same as that shown in the second embodiment, and a split element 711 is used in place of the split element 60.

The split element 711 is split into a first end region 711r, a center region 711c, and a second end region 711l by a splitting line 712 and a splitting line 713. Each of the splitting lines 712 and 713 is an outwardly convex curve. The first end region 711r and the second end region 711l are present even at the end of the split element 711 in the tangential direction (T-axis direction) as the direction of the tangent to the track. Further, inside the center region 711c, two first island-like regions 714 and two second island-like regions 715 are formed.

The split element 711 includes the first island-like regions 714 that are formed into an island-like shape on the center region 711c in the vicinity of the first end region 711r, and the second island-like regions 715 that are formed into the island-like shape on the center region 711c in the vicinity of the second end region 711l. A signal obtained from a light flux having passed through each first island-like region 714 is outputted together with the second signal obtained from the second light flux having passed through the first end region 711r. A signal obtained from a light flux having passed through each second island-like region 715 is outputted together with the third signal obtained from the third light flux having passed through the second end region 711l.

The first island-like region 714 is formed in the vicinity of the splitting line 713 that separates the first end region 711r and the center region 711c. The second island-like region 715 is formed in the vicinity of the splitting line 712 that separates the center region 711c and the second end region 711l. The first island-like region 714 is detected as the same region as the first end region 711r, and the second island-like region 715 is detected as the same region as the second end region 711l. The first island-like region 714 has the same diffraction structure as that of the first end region 711r, and the second island-like region 715 has the same diffraction structure as that of the second end region 711l.

With the presence of the first island-like region 714 and the second island-like region 715, even in the case where one of the first end region 711r and the second end region 711l is reduced due to lens shift, it is possible to alleviate the degree of the change. In addition, also in the case where radial tilt or the like occurs, it is possible to alleviate the change and increase the margin of the crosstalk reduction effect. With this, it becomes possible to reproduce information at a low error rate.

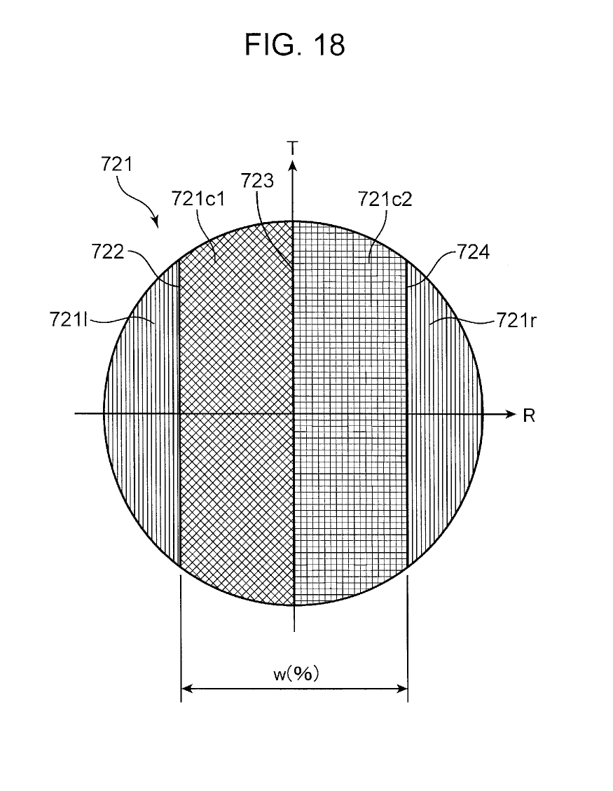

FIG. 18 is a view showing an example of the region split of the split element in a third modification of the second embodiment of the present invention. The optical system is the same as that shown in the second embodiment, and a split element 721 is used in place of the split element 60.

The split element 721 is split into a first end region 721r, a first center region 721c1, a second center region 721c2, and a second end region 7211 by three splitting lines 722, 723, and 724. The splitting lines 722, 723, and 724 are straight lines parallel with the tangential direction (T-axis direction) as the direction of the tangent to the track. Four light beams obtained by splitting by the split element 721 are received by a photodetector having four light receiving section. The four light receiving sections convert the received light beams to electric signals corresponding to the light amounts. Four signals outputted from the four light receiving sections are added up, subjected to signal processing such as the waveform equalization, decoding, and error correction, and outputted as the information reproduction signal. In addition, the light beam having passed through the first end region 721r is received by the first light receiving section 70a, and the light beam having passed through the second end region 7211 is received by the second light receiving section 70b.

### Third Embodiment

A computer according to a third embodiment includes the optical disc information device according to the first embodiment or the second embodiment.

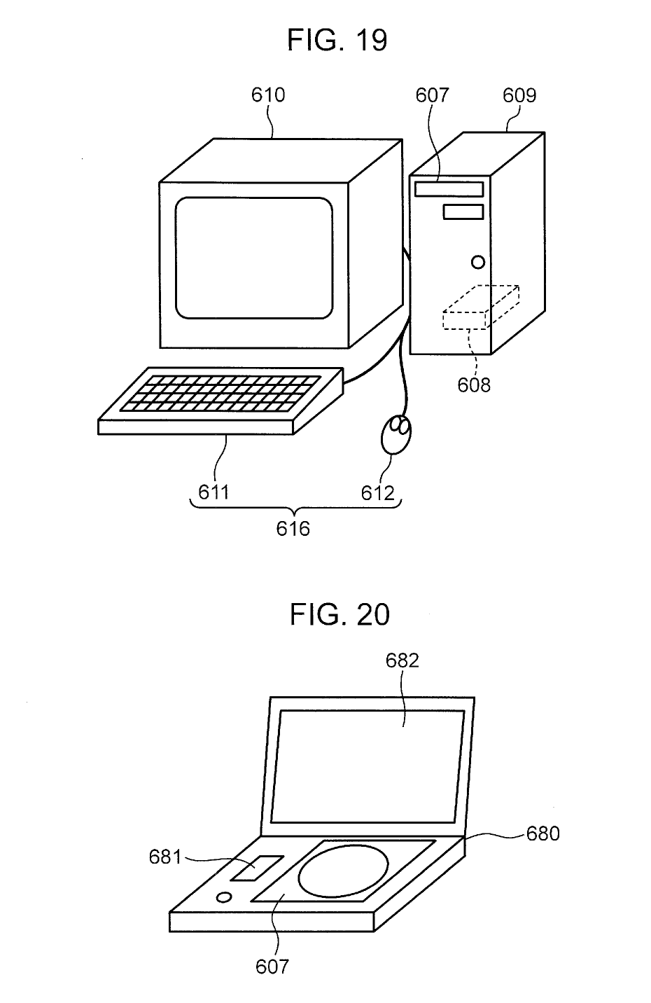

FIG. 19 is a perspective view showing the schematic configuration of the computer according to the third embodiment of the present invention.

A computer 609 shown in FIG. 19 includes an optical disc information device 607 according to the first embodiment or the second embodiment, an input device 616 such as a keyboard 611 or a mouse 612 for inputting information, an arithmetic unit 608 such as a central processing unit (CPU) that performs an arithmetic operation based on information inputted from the input device 616 and information read from the optical disc information device 607, and an output device 610 such as a cathode-ray tube or a liquid crystal display device that displays information such as the result of the arithmetic operation of the arithmetic unit 608 or the like.

The computer 609 according to the present third embodiment includes the optical disc information device 607 according to the first embodiment or the second embodiment, and is capable of detecting the radial tilt amount without being influenced by the lens shift and preventing the occurrence of the coma aberration, and hence the computer 609 can stably record or reproduce information at a low error rate, and can be used in a wide variety of applications.

In addition, the computer 609 may be provided with a wired or wireless input/output terminal that captures information to be recorded in the optical disc information device 607 or outputs information read by the optical disc information device 607 to the outside. With this, the computer 609 can exchange information with a plurality of devices connected to networks such as, e.g., computers, telephones, or television tuners, and can be used as an information server (optical disc server) shared by the plurality of the devices. In addition, the computer 609 can stably record information in different types of optical discs or reproduce the information recorded therein, and hence the computer 609 can be used in a wide variety of applications.

Further, the computer 609 can record/accumulate a large volume of information by including a changer that loads and ejects a plurality of the optical discs into and from the optical disc information device 607. In addition, the computer 609 may include a plurality of the optical disc information devices 607 and may be configured to record information in a plurality of the optical discs or reproduce the information recorded therein simultaneously. With this, it is possible to increase a transfer rate and reduce waiting time required to replace the optical disc.

### Fourth Embodiment

An optical disc player according to a fourth embodiment includes the optical disc information device according to the first embodiment or the second embodiment.

FIG. 20 is a perspective view showing the schematic configuration of the optical disc player according to the fourth embodiment of the present invention.

An optical disc player 680 shown in FIG. 20 includes the optical disc information device 607 according to the first embodiment or the second embodiment, and a decoder 681 that converts an information signal obtained from the optical disc information device 607 to an image signal. In addition, the optical disc player 680 can be used as a car navigation system. Further, the optical disc player 680 may be configured to include a display device 682 such as a liquid crystal monitor or the like.

The optical disc player 680 according to the present fourth embodiment includes the optical disc information device 607 according to the first embodiment or the second embodiment, and is capable of detecting the radial tilt amount without being influenced by the lens shift and preventing the occurrence of the coma aberration, and hence the optical disc player 680 can stably record or reproduce information at a low error rate, and can be used in a wide variety of applications.

### Fifth Embodiment

An optical disc recorder according to a fifth embodiment includes the optical disc information device according to the first embodiment or the second embodiment.

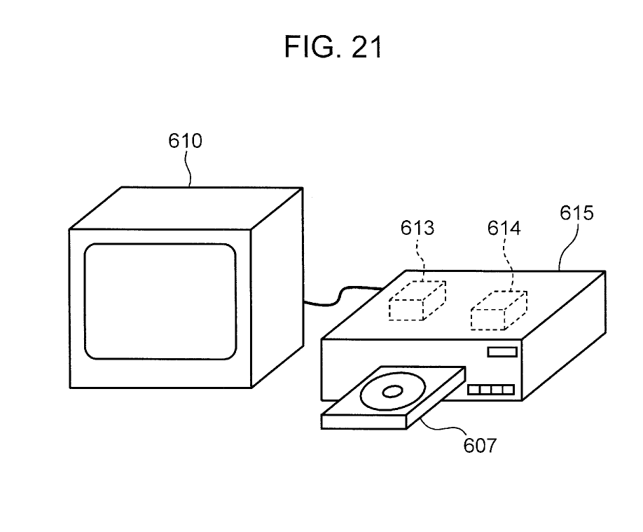

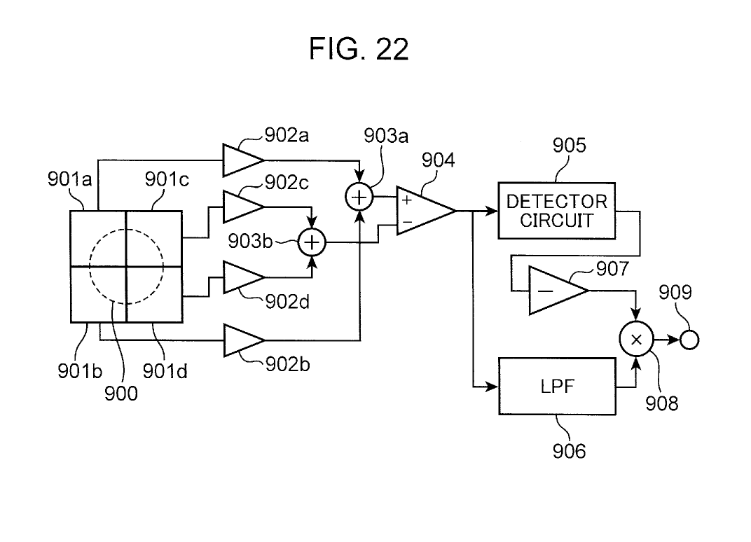

FIG. 21 is a perspective view showing the schematic configuration of the optical disc player according to the fifth embodiment of the present invention.

An optical disc recorder 615 shown in FIG. 21 includes the optical disc information device 607 according to the first embodiment or the second embodiment, and an encoder 613 that converts the image signal to the information signal to be recorded in the optical disc by the optical disc information device 607.

Note that the optical disc recorder 615 preferably also includes a decoder 614 that converts the information signal obtained from the optical disc information device 607 to the image signal. According to this configuration, it becomes possible to reproduce recorded information. Further, the optical disc recorder 615 may include an output device 610 such as the cathode-ray tube or the liquid crystal display device that displays information.

The optical disc recorder 615 according to the present fifth embodiment includes the optical disc information device 607 according to the first embodiment or the second embodiment, and is capable of detecting the radial tilt amount without being influenced by the lens shift and preventing the occurrence of the coma aberration, and hence the optical disc recorder 615 can stably record or reproduce information at a low error rate, and can be used in a wide variety of applications.

Note that the above-described specific embodiments mainly include the invention having the following configurations.

An optical information device according to an aspect of the present invention includes a laser light source that emits a light flux, an objective lens that converges the light flux emitted from the laser light source on an optical information medium, a split element that splits the light flux reflected and diffracted on the optical information medium into a first light flux and a second light flux arranged side by side in a direction perpendicular to a tangent to a track of the optical information medium, a photodetector that receives the first light flux and the second light flux obtained by splitting by the split element, and outputs a first signal and a second signal corresponding to light amounts of the received first light flux and the received second light flux, a filter circuit that extracts a low band component of each of the first signal and the second signal outputted from the photodetector, and extracts a high band component of each of the first signal and the second signal outputted from the photodetector, an arithmetic circuit that generates a high band component difference signal as a difference between the high band component of the first signal extracted by the filter circuit and the high band component of the second signal extracted by the filter circuit and a low band component difference signal as a difference between the low band component of the first signal extracted by the filter circuit and the low band component of the second signal extracted by the filter circuit, adjusts a ratio between the generated high band component difference signal and the generated low band component difference signal, and calculates a difference signal between the high band component difference signal and the low band component difference signal between which the ratio is adjusted, a control signal processing section that generates a tilt control signal based on the difference signal calculated by the arithmetic circuit, and a drive mechanism that tilts the objective lens in a radial direction based on the tilt control signal generated by the control signal processing section.

According to this configuration, the first light flux and the second light flux obtained by splitting by the split element are received, and the first signal and the second signal corresponding to the light amounts of the received first light flux and the received second light flux are outputted. The low band component of each of the first signal and the second signal is extracted, and the high band component of each of the first signal and the second signal is extracted. The high band component difference signal as the difference between the high band component of the first signal and the high band component of the second signal and the low band component difference signal as the difference between the low band component of the first signal and the low band component of the second signal are generated. The ratio between the generated high band component difference signal and the generated low band component difference signal is adjusted, and the difference signal between the high band component difference signal and the low band component difference signal between which the ratio is adjusted is calculated. The tilt control signal is generated based on the calculated difference signal, and the objective lens is tilted in the radial direction based on the generated tilt control signal.

Consequently, by calculating the difference signal between the high band component difference signal and the low band component difference signal, it is possible to reduce the amount of change of the tilt amount of the optical information medium caused by the lens shift, and it is possible to accurately detect the tilt amount of the optical information medium and reliably correct the tilt of the optical information medium even when the lens shift occurs. As a result, it is possible to reduce the coma aberration, and record or reproduce information at a low error rate.

In addition, in the optical information device described above, the split element preferably includes a first region and a second region obtained by splitting using a splitting line passing through the center of the split element and parallel with the tangent to the track, the first region preferably emits the first light flux, and the second region preferably emits the second light flux.

According to this configuration, it is possible to detect the tilt amount of the optical information medium based on the signals obtained from the first light flux and the second light flux obtained by splitting so as to be arranged side by side in the direction perpendicular to the tangent to the track.

Further, in the optical information device described above, the split element preferably includes a center region including the center of the split element, a first region disposed adjacent to the center region in the direction perpendicular to the tangent to the track, and a second region disposed to be symmetrical with the first region relative to an axis corresponding to a straight line passing through the center of the split element and parallel with the tangent to the track, the first region preferably emits the first light flux, and the second region preferably emits the second light flux.

According to this configuration, the light flux having entered the split element is split into three light fluxes and, by using the three light fluxes obtained by the splitting, it is possible to not only correct the tilt amount of the optical information medium but also reduce the crosstalk amount.

Furthermore, in the optical information device described above, when a frequency normalized such that the frequency of one channel clock is 1 is defined as a normalized frequency, the low band component preferably includes a frequency component corresponding to the normalized frequency of 0.05, and the high band component preferably includes a frequency component corresponding to the normalized frequency of 0.2.

According to this configuration, when the frequency normalized such that the frequency of one channel clock is 1 is defined as the normalized frequency, since the low band component includes the frequency component corresponding to the normalized frequency of 0.05, and the high band component includes the frequency component corresponding to the normalized frequency of 0.2, it is possible to obtain the tilt detection signal (difference signal) that is not changed by the lens shift and has the sensitivity only to the tilt of the optical information medium.

A tilt detection method according to another aspect of the present invention includes the steps of emitting a light flux from a laser light source, converging the light flux emitted from the laser light source on an optical information medium using an objective lens, splitting the light flux reflected and diffracted on the optical information medium into a first light flux and a second light flux arranged side by side in a direction perpendicular to a tangent to a track of the optical information medium, receiving the first light flux and the second light flux obtained by the splitting, and outputting a first signal and a second signal corresponding to light amounts of the received first light flux and the received second light flux, extracting a low band component of each of the first signal and the second signal, and extracting a high band component of each of the first signal and the second signal, generating a high band component difference signal as a difference between the extracted high band component of the first signal and the extracted high band component of the second signal and a low band component difference signal as a difference between the extracted low band component of the first signal and the extracted low band component of the second signal, adjusting a ratio between the generated high band component difference signal and the generated low band component difference signal, and calculating a difference signal between the high band component difference signal and the low band component difference signal between which the ratio is adjusted, and generating a tilt control signal based on the calculated difference signal.

According to this configuration, the first light flux and the second light flux obtained by splitting by the split element are received, and the first signal and the second signal corresponding to the light amounts of the received first light flux and the received second light flux are outputted. The low band component of each of the first signal and the second signal is extracted, and the high band component of each of the first signal and the second signal is extracted. The high band component difference signal as the difference between the high band component of the first signal and the high band component of the second signal and the low band component difference signal as the difference between the low band component of the first signal and the low band component of the second signal are generated. The ratio between the generated high band component difference signal and the generated low band component difference signal is adjusted, and the difference signal between the high band component difference signal and the low band component difference signal between which the ratio is adjusted is calculated. The tilt control signal is generated based on the calculated difference signal, and the objective lens is tilted in the radial direction based on the generated tilt control signal.

Consequently, by calculating the difference signal between the high band component difference signal and the low band component difference signal, it is possible to reduce the amount of change of the tilt amount of the optical information medium caused by the lens shift, and it is possible to accurately detect the tilt amount of the optical information medium and reliably correct the tilt of the optical information medium even when the lens shift occurs. As a result, it is possible to reduce the coma aberration, and record or reproduce information at a low error rate.

A computer according to still another aspect of the present invention includes any one of the optical information devices described above, an input section that inputs information, an arithmetic unit that performs an arithmetic operation based on information inputted by the input section and/or information reproduced by the optical information device, and an output section that outputs the information inputted by the input section, the information reproduced by the optical information device, and/or a result of the arithmetic operation by the arithmetic unit. According to this configuration, it is possible to apply the above-described optical information device to the computer.

A player according to yet another aspect of the present invention includes any one of the optical information devices described above, and a decoder that converts an information signal obtained from the optical information device to image information. According to this configuration, it is possible to apply the above-described optical information device to the player.

A recorder according to still another aspect of the present invention includes any one of the optical information devices described above, and an encoder that converts image information to an information signal to be recorded by the optical information device. According to this configuration, it is possible to apply the above-described optical information device to the recorder.

The specific embodiments or examples provided in Description of Embodiments are merely intended to clarify the technical nature of the present invention, and the present invention should not be understood narrowly as limited only to such specific examples. Various modifications can be made within the spirit of the present invention and the scope of claims.

### INDUSTRIAL APPLICABILITY

The optical information device and the tilt detection method according to the present invention are capable of accurately detecting the tilt amount of the optical information medium of which the density is increased and reliably correcting the tilt of the optical information medium, and are useful as an optical information device that records or reproduces information for the optical information medium, and a tilt detection method that detects the tilt of the optical information medium in the optical information device.

In addition, the optical information device according to the present invention can be used in a large capacity memory device for a computer, a server, a computer, a player, and a recorder.

1. An optical information device comprising:
a laser light source that emits a light flux;
an objective lens that converges the light flux emitted from the laser light source on an optical information medium;
a split element that splits the light flux reflected and diffracted on the optical information medium into a first light flux and a second light flux arranged side by side in a direction perpendicular to a tangent to a track of the optical information medium;
a photodetector that receives the first light flux and the second light flux obtained by splitting by the split element, and outputs a first signal and a second signal corresponding to light amounts of the received first light flux and the received second light flux;
a filter circuit that extracts a low band component of each of the first signal and the second signal outputted from the photodetector, and extracts a high band component of each of the first signal and the second signal outputted from the photodetector;
an arithmetic circuit that generates a high band component difference signal as a difference between the high band component of the first signal extracted by the filter circuit and the high band component of the second signal extracted by the filter circuit and a low band component difference signal as a difference between the low band component of the first signal extracted by the filter circuit and the low band component of the second signal extracted by the filter circuit, adjusts a ratio between the generated high band component difference signal and the generated low band component difference signal, and calculates a difference signal between the high band component difference signal and the low band component difference signal between which the ratio is adjusted;
a control signal processing section that generates a tilt control signal based on the difference signal calculated by the arithmetic circuit; and
a drive mechanism that tilts the objective lens in a radial direction based on the tilt control signal generated by the control signal processing section.

2. The optical information device according to claim 1, wherein
the split element includes a first region and a second region obtained by splitting based on a splitting line passing through the center of the split element and parallel with the tangent to the track,
the first region emits the first light flux, and
the second region emits the second light flux.

3. The optical information device according to claim 1, wherein
the split element includes a center region including the center of the split element, a first region disposed adjacent to the center region in the direction perpendicular to the tangent to the track, and a second region disposed to be symmetrical with the first region relative to an axis corresponding to a straight line passing through the center of the split element and parallel with the tangent to the track,
the first region emits the first light flux, and
the second region emits the second light flux.

4. The optical information device according to claim 1, wherein
when a frequency, normalized such that the frequency of one channel clock is 1, is defined as a normalized frequency,
the low band component includes a frequency component corresponding to the normalized frequency of 0.05, and
the high band component includes a frequency component corresponding to the normalized frequency of 0.2.

5. A tilt detection method comprising:
a step of emitting a light flux from a laser light source;
a step of converging the light flux emitted from the laser light source on an optical information medium by using an objective lens;
a step of splitting the light flux reflected and diffracted on the optical information medium into a first light flux and a second light flux arranged side by side in a direction perpendicular to a tangent to a track of the optical information medium;
a step of receiving the first light flux and the second light flux obtained by the splitting, and outputting a first signal and a second signal corresponding to light amounts of the received first light flux and the received second light flux;
a step of extracting a low band component of each of the first signal and the second signal, and extracting a high band component of each of the first signal and the second signal;
a step of generating a high band component difference signal as a difference between the extracted high band component of the first signal and the extracted high band component of the second signal and a low band component difference signal as a difference between the extracted low band component of the first signal and the extracted low band component of the second signal, and adjusting a ratio between the generated high band component difference signal and the generated low band component difference signal, and moreover calculating a difference signal between the high band component difference signal and the low band component difference signal between which the ratio is adjusted; and
a step of generating a tilt control signal based on the calculated difference signal.

6. A computer comprising:
the optical information device according to claim 1;
an input section that inputs information;
an arithmetic unit that performs an arithmetic operation based on information inputted by the input section and/or information reproduced by the optical information device; and
an output section that outputs the information inputted by the input section, the information reproduced by the optical information device, and/or a result of the arithmetic operation by the arithmetic unit.

7. A player comprising:
the optical information device according to claim 1; and
a decoder that converts an information signal obtained from the optical information device to image information.

8. A recorder comprising:
the optical information device according to claim 1; and
an encoder that converts image information to an information signal to be recorded by the optical information device.
